(19) United States
(12) Patent Application Publication
(10) Pub. No.: US 2022/0342419 A1
(43) Pub. Date: Oct. 27, 2022

(54) METHOD AND APPARATUS FOR AUXILIARY FOCUSING AND UNMANNED AERIAL VEHICLE

(71) Applicant: Autel Robotics Co., Ltd., Shenzhen (CN)

(72) Inventor: Defei JIANG, Shenzhen (CN)

(21) Appl. No.: 17/652,152

(22) Filed: Feb. 23, 2022

Related U.S. Application Data
(63) Continuation of application No. PCT/CN2020/110590, filed on Aug. 21, 2020.

(30) Foreign Application Priority Data
Aug. 23, 2019 (CN) 201910784858.4

(51) Int. Cl. G05D 1/00; B64C 39/02; B64D 47/08; G05D 1/10

(52) U.S. Cl. CPC G05D 1/0094; B64C 39/02; B64D 47/08; G05D 1/102; B64C 2201/127

(57) ABSTRACT

Embodiments of the present invention relate to the technical field of automatic focusing, and disclose an auxiliary focusing method and apparatus and an unmanned aerial vehicle (UAV). The auxiliary focusing method is applicable to a UAV. The UAV includes a shooting device. The method includes: determining a position offset of the UAV; and controlling, according to the position offset of the UAV, the shooting device to perform focusing. In this way, the embodiments of the disclosure can capture relatively clear video images in different flight environments.

### CROSS-REFERENCE TO RELATED APPLICATIONS

The present application is a continuation of International Application No. PCT/CN2020/110590, filed on Aug. 21, 2020, which claims priority to Chinese Patent Application No. 201910784858.4, filed on Aug. 23, 2019, which is incorporated herein by reference in its entirety.

### TECHNICAL FIELD

The present application relates to the technical field of automatic focusing, and in particular, to an auxiliary focusing method and apparatus and an unmanned aerial vehicle (UAV).

### BACKGROUND

An unmanned aerial vehicle (UAV) is an unmanned vehicle operated by a radio remote control device or a program control apparatus of the UAV, which is frequently used for aerial photography.

During the aerial photography of the UAV, the location of the shooting device is prone to change, resulting in insufficiently clear video images.

### SUMMARY

Embodiments of the disclosure are intended to provide an auxiliary focusing method and apparatus and an unmanned aerial vehicle (UAV), so as to shoot relatively clear video images in different flight environments.

In order to resolve the foregoing technical problem, the embodiments of the disclosure adopt a technical solution as follows. An auxiliary focusing method is provided, applicable to a UAV, where the UAV includes a shooting device, and the method includes:

determining a position offset of the UAV; and

controlling, according to the position offset of the UAV, the shooting device to perform focusing.

Optionally, the determining a position offset of the UAV includes:

acquiring current position information of the UAV and position information at a previous moment; and

calculating the position offset of the UAV according to the current position information and the position information at the previous moment.

Optionally, the position information includes spatial coordinate information of the UAV; and

the calculating the position offset of the UAV according to the current position information and the position information at the previous moment includes:

calculating the position offset of the UAV according to spatial coordinate information at a current moment and spatial coordinate information at a previous moment.

Optionally, the UAV includes a gyroscope.

The spatial coordinate information of the UAV is acquired by using the gyroscope.

Optionally, the controlling, according to the position offset of the UAV, the shooting device to perform focusing includes:

controlling the shooting device to perform focusing if the position offset of the UAV is greater than or equal to a preset position offset.

In order to resolve the foregoing technical problem, the embodiments of the disclosure adopt another technical solution as follows. An auxiliary focusing apparatus is provided, applicable to a UAV. The UAV includes a shooting device, and the apparatus includes:

a determining module, configured to determine a position offset of the UAV; and

a control module, configured to control, according to the position offset of the UAV, the shooting device to perform focusing.

Optionally, the determining module is specifically configured to:

acquire current position information of the UAV and position information at a previous moment; and

calculate the position offset of the UAV according to the current position information and the position information at the previous moment.

Optionally, the position information includes spatial coordinate information of the UAV; and

the determining module is specifically configured to:

calculate the position offset of the UAV according to spatial coordinate information at a current moment and spatial coordinate information at a previous moment.

Optionally, the control module is specifically configured to:

control the shooting device to perform focusing if the position offset of the UAV is greater than or equal to a preset position offset.

In order to resolve the foregoing technical problem, the embodiments of the disclosure adopt another technical solution as follows. A UAV is provided, including:

a fuselage;

an arm, connected with the fuselage;

a power apparatus, disposed on the arm;

a shooting device, connected with the fuselage;

a gyroscope, disposed on the fuselage and configured to acquire spatial coordinate information of the UAV;

at least one processor; and

a memory, communicatively connected with the at least one processor, where the memory stores instructions executable by the at least one processor, the instructions, when executed by the at least one processor, causing the at least one processor to perform the auxiliary focusing method described above.

Optionally, the UAV further includes a gimbal, and the shooting device is connected with the fuselage by using the gimbal.

In order to resolve the foregoing technical problem, the embodiments of the disclosure adopt another technical solution as follows. A non-volatile computer-readable storage medium is provided, storing computer executable instructions causing a UAV to perform the above auxiliary focusing method.

Beneficial effects of the embodiments of the disclosure are as follows. Different from the prior art, the embodiments of the disclosure provide an auxiliary focusing method and apparatus and a UAV. In the auxiliary focusing method, it is determined, by determining the position offset of the UAV, whether to control the shooting device to perform focusing, so that the shooting device performs focusing when the position changes, and the focusing is more accurate, thereby shooting a relatively clear video image.

### BRIEF DESCRIPTION OF THE DRAWINGS

One or more embodiments are exemplarily described with reference to the corresponding figures in the accompanying drawings, and the descriptions are not to be construed as limiting the embodiments. Components in the accompanying drawings that have same reference numerals are represented as similar components, and unless otherwise particularly stated, the figures in the accompanying drawings are not drawn to scale.

FIG. 1 is a schematic structural diagram of an unmanned aerial vehicle (UAV) according to an embodiment of the disclosure.

FIG. 2 is a schematic flowchart of an auxiliary focusing method according to an embodiment of the disclosure.

FIG. 3 is a schematic structural diagram of an auxiliary focusing apparatus according to an embodiment of the disclosure.

FIG. 4 is a schematic structural diagram of hardware of a UAV according to an embodiment of the disclosure.

### DETAILED DESCRIPTION

To make the objectives, technical solutions, and advantages of the embodiments of the present invention clearer, the following clearly and completely describes the technical solutions in the embodiments of the present invention with reference to the accompanying drawings in the embodiments of the present invention. Apparently, the described embodiments are merely some rather than all of the embodiments of the present invention. It should be understood that the specific embodiments described herein are merely used for explaining the present invention but are not intended to limit the present invention. All other embodiments obtained by a person of ordinary skill in the art based on the embodiments of the present invention without creative efforts shall fall within the protection scope of the present invention.

It should be noted that, when a component is expressed as “being fixed to” another component, the component may be directly on the another component, or one or more intermediate components may exist between the component and the another component. When one component is expressed as “being connected to” another component, the component may be directly connected to the another component, or one or more intermediate components may exist between the component and the another component. The terms “vertical”, “horizontal”, “left”, “right”, and similar expressions in this specification are merely used for an illustrative purpose.

In addition, technical features involved in the embodiments of the present invention described below may be combined with each other provided that there is no conflict between each other.

The disclosure provides an auxiliary focusing method and apparatus. The method and apparatus are applicable to an unmanned aerial vehicle (UAV), so that the UAV controls, according to a position offset, a shooting device to perform focusing, thereby improving the focusing accuracy of the shooting device, and shooting relatively clear video images. The UAV may be any suitable type of high-altitude UAV or low-altitude UAV equipped with the shooting device for aerial photography. The UAV includes a fixed-wing UAV, a rotary-wing UAV, an umbrella-wing UAV, or the like.

The present invention will be described below in detail by using specific embodiments.

### EMBODIMENT I

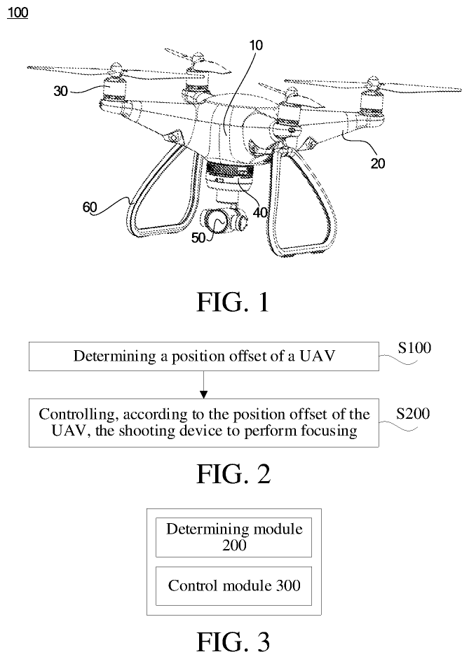

Referring to FIG. 1, a UAV 100 according to an embodiment of the disclosure is shown, including: a fuselage 10, an arm 20, a power apparatus 30, a gimbal 40, a shooting device 50, a gyroscope (not shown), an undercarriage 60 and a flight control system (not shown). The arm 20, the gimbal 40 and the undercarriage 60 are all connected with the fuselage 10. The power apparatus 30 is disposed on the arm 20. The shooting device 50 and the gyroscope are mounted to the gimbal 40, and the flight control system is disposed in the fuselage 10. The power apparatus 30, the gimbal 40, the shooting device 50, the gyroscope, and the undercarriage 60 are all communicatively connected with the flight control system. The flight control system is capable of controlling the flight of the UAV 100 by using the power apparatus 30, controlling the gimbal 40 to rotate, controlling the shooting device 50 to perform aerial photography, controlling the undercarriage 60 to be unfolded and retracted, and receiving measurement data of the gyroscope.

Preferably, four arms 20 are provided and are uniformly distributed around the fuselage 10 for carrying the power apparatus 30.

The power apparatus 30 includes a motor and a propeller connected to a motor shaft. The motor can drive the propeller to rotate to provide lift for the UAV 100 to achieve flight. The motor can further change a flight direction of the UAV 100 by changing a rotational speed and a rotation direction of the propeller. When the power apparatus 30 is communicatively connected with the flight control system, the flight control system is capable of controlling the flight of the UAV 100 by controlling the motor.

The power apparatus 30 is disposed at an end of the arm 20 that is not connected with the fuselage 10, and is connected with the arm 20 by the motor.

Preferably, the power apparatus 30 is disposed on each of the four arms of the UAV 100 to cause the UAV 100 to fly stably.

The gimbal 40 is disposed at the bottom of the fuselage 10 for carrying the shooting device 50. Preferably, the gimbal 40 is an electric gimbal that is rotatable under the control of the flight control system, including but not limited to a horizontal rotary gimbal, an omnidirectional gimbal and the like.

When the gimbal 40 is the horizontal rotary gimbal, the flight control system controls the gimbal 40 to rotate left and right in a horizontal direction.

When the gimbal 40 is the omnidirectional gimbal, the flight control system can control the gimbal 40 to rotate left and right in the horizontal direction, and controls the gimbal 40 to rotate up and down in a vertical direction.

The shooting device 50 may be a device capable of shooting video images, such as a camera, a video camera and the like, which is configured to perform aerial photography under the control of the flight control system. In addition, during the aerial photography of the shooting device 50, the shooting device 50 can perform automatic focusing, so that the captured video images are clear.

The shooting device 50 is fixed to the gimbal 40 and rotatable with the rotation of the gimbal 40 to shoot video images at different viewing angles. Certainly, in some alternative embodiments, the shooting device 50 can also be directly fixed to the fuselage 10.

The gyroscope is disposed on the gimbal 40 and is configured to measure spatial coordinate information of the UAV 100. The spatial coordinate information includes an x-axis coordinate, a y-axis coordinate and a z-axis coordinate. After the gyroscope is communicatively connected with the flight control system, the flight control system can acquire the spatial coordinate information of the UAV 100 from the gyroscope.

It may be understood that, in some alternative embodiments, when the shooting device 50 is directly fixed to the fuselage 10, the gyroscope can also be disposed on the fuselage 10.

The undercarriage 60 is disposed on two opposite sides of the bottom of the fuselage 10, and is connected with the fuselage 10 by a driving apparatus. The undercarriage 60 may be driven by the driving apparatus to be unfolded and retracted. When the UAV 100 comes into contact with the ground, the driving apparatus controls the undercarriage 60 to be unfolded, so that the UAV 100 comes into contact with the ground by using the undercarriage 60. During the flight of the UAV 100, the driving apparatus controls the undercarriage 60 to be retracted to prevent the undercarriage 60 from affecting the flight of the UAV 100. When the undercarriage 60 is communicatively connected with the flight control system, the flight control system can control the unfolding and retraction of the undercarriage 60 by controlling the driving apparatus.

The flight control system is communicatively connected with the power apparatus 30, the gimbal 40, the shooting device 50, the gyroscope and the undercarriage 60 by means of wired connection or wireless connection. The wireless connection includes but is not limited to Wi-Fi, Bluetooth, ZigBee and the like.

The flight control system is configured to perform the auxiliary focusing method to improve the focusing accuracy of the shooting device 50, so that the shooting device 50 can shoot a relatively clear video image.

Specifically, after the flight control system controls the shooting device 50 to perform aerial photography, the flight control system determines the position offset of the UAV 100.

The position offset of the UAV 100 is a straight-line distance between a current position of the UAV 100 and a position at a previous moment.

Based on this, the flight control system acquires current position information of the UAV 100 and position information at the previous moment when determining the position offset of the UAV 100, and calculates the position offset of the UAV 100 according to the acquired current position information and the position information at the previous moment.

The position information includes the spatial coordinate information.

The current position information of the UAV 100 includes spatial coordinate information of the UAV 100 at a current moment.

The position information of the UAV 100 at the previous moment includes the spatial coordinate information of the UAV 100 at the previous moment.

In this way, the flight control system acquires the current position information and the position information of the UAV 100 at the previous moment, that is, acquires the spatial coordinate information of the UAV 100 at the current moment and the spatial coordinate information at the previous moment.

Since the gyroscope can measure the spatial coordinate information of the UAV 100, the flight control system acquires the spatial coordinate information at the current moment and the spatial coordinate information of the UAV 100 at the previous moment from the gyroscope.

The position offset of the UAV 100 is calculated according to the acquired current position information and the position information at the previous moment. That is, the position offset of the UAV 100 is calculated according to the acquired spatial coordinate information at the current moment and the spatial coordinate information at the previous moment.

For example, when the spatial coordinate information of the UAV 100 at the current moment acquired by the flight control system from the gyroscope is (x1, y1, z1) and the spatial coordinate information at the previous moment is (x2, y2, z2), the obtained position offset of the UAV 100 is calculated by using d=\sqrt{(x1−x2)² +(y1−y2)² +(z1−z2)²}.

Since the position offset of the UAV 100 can be obtained by acquiring the spatial coordinate information measured by the gyroscope, a complex calculation is not required for calculating a distance between the shooting device and a to-be-photographed object, which greatly reduces the calculation amount, so as to increase the response speed of the shooting device, so that the automatic focusing of the shooting device 50 can be more accurate.

After the flight control system determines the position offset of the UAV 100, the shooting device 50 is controlled, according to the determined position offset, to perform focusing.

When the shooting device 50 is controlled, according to the determined position offset, to perform focusing, it is determined whether the determined position offset is greater than or equal to a preset position offset. If the determined position offset is greater than or equal to the preset position offset, the shooting device 50 is controlled to perform focusing. Otherwise, the shooting device 50 is not controlled to perform focusing.

The preset position offset is a preset reference value for guiding the focusing of the shooting device 50, and is an empirical value obtained through a plurality of experiments. For example, the preset position offset may be 5.5.

The preset position offset may be set by a user by using an application program of the UAV 100.

Further, in some alternative embodiments, the UAV 100 can further perform the auxiliary focusing method by using the shooting device 50. When the auxiliary focusing method is performed by using the shooting device 50, the shooting device 50 is further communicatively connected with the gyroscope, so as to acquire the spatial coordinate information of the UAV 100 from the gyroscope.

Specifically, after the flight control system controls the shooting device 50 to perform aerial photography, the shooting device 50 acquires the spatial coordinate information of the UAV 100 at the current moment and the spatial coordinate information at the previous moment from the gyroscope. The position offset of the UAV 100 is calculated according to the acquired spatial coordinate information at the current moment and the spatial coordinate information at the previous moment. It is determined whether the calculated position offset is greater than or equal to the preset position offset. If the calculated position offset is greater than or equal to the preset position offset, focusing is performed, otherwise, focusing is not performed.

In this embodiment of the disclosure, by performing the auxiliary focusing method, the UAV can control, according to the position offset, the shooting device to perform focusing, so that the shooting device can perform focusing when the position changes, thereby improving the focusing accuracy of the shooting device, and causing the shooting device to shoot relatively clear video images.

### EMBODIMENT II

Referring to FIG. 2, FIG. 2 is a schematic flowchart of an auxiliary focusing method according to an embodiment of the disclosure, which is applicable to a UAV. The UAV is the UAV 100 described in the above embodiment. The method provided in this embodiment of the disclosure may be performed by the above flight control system or may be performed by the above shooting device 50 to improve the focusing accuracy of the shooting device 50, so that the shooting device 50 can shoot a relatively clear video image. The auxiliary focusing method includes the following steps.

S100: Determining a position offset of a UAV.

The position offset of the UAV is a straight-line distance between a current position of the UAV and a position at a previous moment.

In this way, the determining a position offset of a UAV specifically includes: acquiring current position information of the UAV and position information at a previous moment; and calculating the position offset of the UAV according to the acquired current position information and the position information at the previous moment.

The position information includes spatial coordinate information.

The current position information of the UAV includes the spatial coordinate information of the UAV at a current moment.

The position information of the UAV at the previous moment includes the spatial coordinate information of the UAV at the previous moment.

In this way, the current position information of the UAV and the position information at the previous moment are acquired, that is, the spatial coordinate information of the UAV at the current moment and the spatial coordinate information at the previous moment are acquired.

Since the gyroscope can measure the spatial coordinate information of the UAV, the spatial coordinate information of the UAV at the current moment and the spatial coordinate information at the previous moment are acquired from the gyroscope.

The position offset of the UAV is calculated according to the acquired current position information and the position information at the previous moment. That is, the position offset of the UAV is calculated according to the acquired spatial coordinate information at the current moment and the spatial coordinate information at the previous moment.

For example, when the spatial coordinate information of the UAV at the current moment acquired from the gyroscope is (x1, y1, z1) and the spatial coordinate information at the previous moment is (x2, y2, z2), the obtained position offset of the UAV 100 is calculated by using d=\sqrt{(x1−x2)² +(y1−y2)² +(z1−z2)²}.

Since the position offset of the UAV 100 can be obtained by acquiring the spatial coordinate information measured by the gyroscope, a complex calculation is not required for calculating a distance between the shooting device and a to-be-photographed object, which greatly reduces the calculation amount, so as to increase the response speed of the shooting device, so that the automatic focusing of the shooting device 50 can be more accurate.

S200: Controlling, according to the position offset of the UAV, the shooting device to perform focusing.

Specifically, it is determined whether the determined position offset is greater than or equal to a preset position offset. If the determined position offset is greater than or equal to the preset position offset, the shooting device is controlled to perform focusing. Otherwise, the shooting device is not controlled to perform focusing.

The preset position offset is a preset reference value for guiding the focusing of the shooting device, and is an empirical value obtained through a plurality of experiments. For example, the preset position offset may be 5.5.

The preset position offset may be set by a user by using an application program of the UAV.

In this embodiment of the disclosure, it is determined, by determining the position offset of the UAV, whether to control the shooting device to perform focusing, so that the shooting device can perform focusing when the position changes, thereby improving the focusing accuracy of the shooting device, and causing the shooting device to shoot relatively clear video images.

### EMBODIMENT III

The following term “module” may refer to a combination of software and/or hardware having a predetermined function. Although the apparatus described in the following embodiments may be implemented by using software, it is also conceivable that the apparatus may be implemented by using hardware, or a combination of software and hardware.

Referring to FIG. 3, an auxiliary focusing apparatus according to an embodiment of the disclosure is provided, which is applicable to a UAV. The UAV is the UAV 100 described in the above embodiment. However, the functions of each module of the apparatus provided in this embodiment of the disclosure may be performed by the above flight control system or may be performed by the above shooting device 50 to improve the focusing accuracy of the shooting device 50, so that the shooting device 50 can shoot a relatively clear video image. The auxiliary focusing apparatus includes:

a determining module 200, configured to determine a position offset of the UAV; and

a control module 300, configured to control, according to the position offset of the UAV, the shooting device to perform focusing.

The determining module 200 is specifically configured to:

acquire current position information of the UAV and position information at a previous moment; and

calculate the position offset of the UAV according to the current position information and the position information at the previous moment.

The position information includes spatial coordinate information of the UAV.

The determining module 200 is specifically configured to:

calculate the position offset of the UAV according to spatial coordinate information at a current moment and spatial coordinate information at a previous moment.

The control module 300 is specifically configured to:

control the shooting device to perform focusing if the position offset of the UAV is greater than or equal to a preset position offset.

Certainly, in some other alternative embodiments, the determining module 200 and the control module 300 may be flight control chips in the flight control system, or may be image processing chips in the shooting device 50.

The apparatus embodiment and the method embodiment are based on the same concept. Therefore, for the content of the apparatus embodiment, reference may be made to the method embodiment without mutual conflict among content, and details are not described herein again.

In this embodiment of the disclosure, it is determined, by determining the position offset of the UAV, whether to control the shooting device to perform focusing, so that the shooting device can perform focusing when the position changes, thereby improving the focusing accuracy of the shooting device, and causing the shooting device to shoot relatively clear video images.

### EMBODIMENT IV

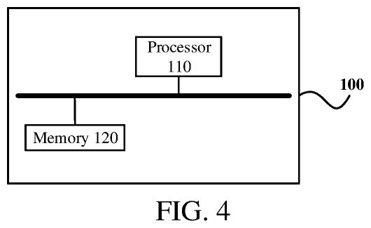

Referring to FIG. 4, FIG. 4 is a schematic structural diagram of hardware of a UAV according to an embodiment of the disclosure. Hardware modules provided in the embodiments of the disclosure can be integrated into the flight control system described in the foregoing embodiments, and can also be integrated into the shooting device 50 described in the foregoing embodiments, so that the UAV 100 can perform the auxiliary focusing method described in the foregoing embodiments, and can also implement the functions of each module of the auxiliary focusing apparatus described in the above embodiments.

The UAV 100 includes

one or more processors 110 and a memory 120. In FIG. 4, one processor 110 is used as an example.

In some embodiments, the processor 110 may be a flight controller.

The processor 110 and the memory 120 may be connected by using a bus or in other manners. In FIG. 4, the bus is used for connection by way of example.

As a non-volatile computer-readable storage medium, the memory 120 may be configured to store a non-volatile software program, a non-volatile computer executable program and a module, such as a program instruction corresponding to the auxiliary focusing method and the modules (for example, the determining module 200 and the control module 300) corresponding to the auxiliary focusing apparatus in the foregoing embodiments of the disclosure. The processor 110 executes various functional applications and data processing of the auxiliary focusing method by running a non-volatile software program, an instruction and a module stored in the memory 120. That is to say, the auxiliary focusing method in the foregoing method embodiment and the functions of the modules in the foregoing apparatus embodiment are implemented.

The memory 120 may include a program storage area and a data storage area. The program storage area may store an operating system and an application program required for at least one function. The data storage area may store data created according to the use of the auxiliary focusing apparatus and the like.

The data storage area further stores preset data, including a preset time, a preset position offset and the like.

In addition, the memory 120 may include a high-speed random access memory, and may further include a non-volatile memory, such as at least one magnetic disk memory device, a flash memory device or other non-volatile solid-state memory devices. In some embodiments, the memory 120 optionally includes remote memories disposed relative to the processor 110. These remote memories may be connected with the processor 110 via a network. An example of the foregoing network includes, but is not limited to, the Internet, an intranet, a local area network, a mobile communications network and a combination thereof.

The program instruction and the one or more modules are stored in the memory 120. The program instruction, when executed by the one or more processors 110, causes the one or more processors to perform the steps of the auxiliary focusing method in any of the foregoing method embodiments or implement the functions of the modules of the auxiliary focusing apparatus in any of the foregoing apparatus embodiments.

For the foregoing product, the method provided in the embodiments of the present invention may be performed, and the corresponding functional modules for performing the method and beneficial effects thereof are provided. For technical details not described in detail in this embodiment, reference may be made to the method provided in the foregoing embodiments of the present invention.

An embodiment of the disclosure further provides a non-volatile computer-readable storage medium, storing computer-executable instructions. The computer-executable instructions, when executed by one or more processors, for example, the processor 110 in FIG. 4, cause a computer to perform the steps of the auxiliary focusing method in any of the foregoing method embodiments or implement the functions of the modules of the auxiliary focusing apparatus in any of the foregoing apparatus embodiments.

An embodiment of the disclosure further provides a computer program product, including a computer program stored in the non-volatile computer-readable storage medium. The computer program includes program instructions. The program instructions, when executed by one or more processors, for example, the processor 110 in FIG. 4, cause a computer to perform the steps of the auxiliary focusing method in any of the foregoing method embodiments or implement the functions of the modules of the auxiliary focusing apparatus in any of the foregoing apparatus embodiments.

The described apparatus embodiment is merely an example. The modules described as separate parts may or may not be physically separated, and parts displayed as modules may or may not be physical units, may be located in one position, or may be distributed on a plurality of network units. Some or all of the modules may be selected according to actual requirements to implement the objectives of the solutions of the embodiments.

Through the description of the foregoing embodiments, a person skilled in the art may clearly understand that the embodiments may be implemented by software in combination with a universal hardware platform, and may certainly be implemented by hardware. A person of ordinary skill in the art may understand that all or some of the processes of the methods in the foregoing embodiments may be implemented by a computer program instructing relevant hardware. The program may be stored in a computer-readable storage medium. During execution of the program, processes of the foregoing method embodiments may be included. The foregoing storage medium may be a magnetic disk, an optical disc, a read-only memory (ROM), a random access memory (RAM) or the like.

The foregoing descriptions are embodiments of the present invention, and the protection scope of the present invention is not limited thereto. All equivalent structure or process changes made according to the content of this specification and accompanying drawings in the present invention or by directly or indirectly applying the present invention in other related technical fields shall fall within the protection scope of the present invention.

Finally, it should be noted that: the foregoing embodiments are merely used for describing the technical solutions of the present invention, but are not intended to limit the present invention. Under the ideas of the present invention, the technical features in the foregoing embodiments or different embodiments may also be combined, the steps may be performed in any order, and many other changes of different aspects of the present invention also exist as described above, and these changes are not provided in detail for simplicity. Although the present invention is described in detail with reference to the foregoing embodiments, it should be appreciated by a person skilled in the art that, modifications may still be made to the technical solutions described in the foregoing embodiments, or equivalent replacements may be made to the part of the technical features; and these modifications or replacements will not cause the essence of corresponding technical solutions to depart from the scope of the technical solutions in the embodiments of this application.

What is claimed is:

1. An auxiliary focusing method, applicable to an unmanned aerial vehicle (UAV), wherein the UAV comprises a shooting device, the method comprising:
determining a position offset of the UAV; and
controlling, according to the position offset of the UAV, the shooting device to perform focusing.

2. The method according to claim 1, wherein the determining a position offset of the UAV comprises:
acquiring current position information of the UAV and position information at a previous moment; and
calculating the position offset of the UAV according to the current position information and the position information at the previous moment.

3. The method according to claim 2, wherein the position information comprises spatial coordinate information of the UAV; and
the calculating the position offset of the UAV according to the current position information and the position information at the previous moment comprises:
calculating the position offset of the UAV according to spatial coordinate information at a current moment and spatial coordinate information at a previous moment.

4. The method according to claim 3, wherein The UAV comprises a gyroscope; and
the spatial coordinate information of the UAV is acquired by using the gyroscope.

5. The method according to claim 1, wherein the controlling, according to the position offset of the UAV, the shooting device to perform focusing comprises:
controlling the shooting device to perform focusing if the position offset of the UAV is greater than or equal to a preset position offset.

6. An auxiliary focusing apparatus, applicable to an unmanned aerial vehicle (UAV), wherein the UAV comprises a shooting device, the apparatus comprising:
at least one processor; and
a memory, communicatively connected with the at least one processor, wherein the memory stores instructions executable by the at least one processor; and the instructions, when executed by the at least one processor, cause the at least one processor to:
determine a position offset of the UAV; and
control, according to the position offset of the UAV, the shooting device to perform focusing.

7. The apparatus according to claim 6, wherein the processor is specifically configured to:
acquire current position information of the UAV and position information at a previous moment; and
calculate the position offset of the UAV according to the current position information and the position information at the previous moment.

8. The apparatus according to claim 7, wherein the position information comprises spatial coordinate information of the UAV; and
the processor is specifically configured to:
calculate the position offset of the UAV according to spatial coordinate information at a current moment and spatial coordinate information at a previous moment.

9. The apparatus according to claim 6, wherein the processor is specifically configured to:
control the shooting device to perform focusing if the position offset of the UAV is greater than or equal to a preset position offset.

10. An unmanned aerial vehicle (UAV), comprising:
a fuselage;
an arm, connected with the fuselage;
a power apparatus, disposed on the arm;
a shooting device, connected with the fuselage;
a gyroscope, disposed on the fuselage and configured to acquire spatial coordinate information of the UAV;
at least one processor; and
a memory, communicatively connected with the at least one processor, wherein the memory stores instructions executable by the at least one processor; and the instructions, when executed by the at least one processor, cause the at least one processor to:
determine a position offset of the UAV; and
control, according to the position offset of the UAV, the shooting device to perform focusing.

11. The UAV according to claim 10, further comprising a gimbal, wherein the shooting device is connected with the fuselage by using the gimbal.

12. The UAV according to claim 10, wherein the processor is further configured to:
acquire current position information of the UAV and position information at a previous moment; and
calculate the position offset of the UAV according to the current position information and the position information at the previous moment.

13. The UAV according to claim 12, wherein the position information comprises spatial coordinate information of the UAV; and
the processor is further configured to:
calculate the position offset of the UAV according to spatial coordinate information at a current moment and spatial coordinate information at a previous moment.

14. The UAV according to claim 10, wherein the processor is further configured to:
control the shooting device to perform focusing if the position offset of the UAV is greater than or equal to a preset position offset.

15. A non-transitory computer readable memory medium storing program instructions executable by processing circuitry to cause a processor to:
determine a position offset of the UAV; and
control, according to the position offset of the UAV, the shooting device to perform focusing.

16. The non-transitory memory medium according to claim 15, wherein the program instructions are further executable to:
acquire current position information of the UAV and position information at a previous moment; and
calculate the position offset of the UAV according to the current position information and the position information at the previous moment.

17. The non-transitory memory medium according to claim 16, wherein the position information comprises spatial coordinate information of the UAV; and
the program instructions are further executable to:
calculate the position offset of the UAV according to spatial coordinate information at a current moment and spatial coordinate information at a previous moment.

18. The non-transitory memory medium according to claim 15, wherein the program instructions are further executable to:
control the shooting device to perform focusing if the position offset of the UAV is greater than or equal to a preset position offset.
